(19) United States
(12) Patent Application Publication
(10) Pub. No.: US 2025/0017357 A1
(43) Pub. Date: Jan. 16, 2025

(54) Water on the Run

(71) Applicant: Jamal Ghani, Flint, MI (US)

(72) Inventor: Jamal Ghani, Flint, MI (US)

(21) Appl. No.: 18/221,268

(22) Filed: Jul. 12, 2023

(51) Int. Cl. A45F 3/20; A45F 3/00

(52) U.S. Cl. CPC A45F 3/20; A45F 3/005; A45F 2003/003; A45F 2003/166; A45F 2200/0516; F21V 33/0004

(57) ABSTRACT

A portable solution for people allowing to hold water while they are on outdoor activities with a variety of features. The assembly includes multiple features including but not limited to easy access to water with a fanny-pack system on the user's waist with a retractable water tube along with access to the rechargeable battery pack, LED light for safety, and a storage compartment.

### COPYRIGHT NOTICE

A portion of the disclosure of this patent document contains material which is subject to copyright protection. The copyright owner has no objection to the xeroxographic reproduction by anyone of the patent document or the patent disclosure in exactly the form it appears in the Patent and Trademark Office patent file or records, but otherwise reserves all copyright rights whatsoever.

### BACKGROUND

### Field of the Invention

The present invention relates to an improved structure of a water-holding assembly and more specifically, the present invention is a multipurpose water storage, water bladder system with integrated with fanny pack that has multiple functions and uses. The proposed invention will be very useful for working people, people who travel often, and people who go to the gym.

### Description of the Related Art

The present invention relates to a water storage, water bladder system with integrated with fanny pack that is useful in the course of daily household work and activities. More specifically, the present invention is a multipurpose system that has multiple functions and uses. The multipurpose system will be very useful for working people, people who travel often, and for people who go to the gym.

At present, there is not a system of this type available that has multiple useful features, such as: insulation to keep the water cool for a longer period of time, a smartphone holder, a smart phone charger, a Bluetooth speaker, an optional fragrance tab and storage space for personal items such as keys, credit cards, money, etc. Currently, if people want to carry all these items then they have to use a bag of dimensions of approximately 6×8×10 inches but nevertheless will still be unable to charge smart phones or work as a Bluetooth speaker. While there may be many multipurpose bottles available, none of them have all of the above-mentioned features.

For example, Chinese Patent Number CN203127268 was granted for a multipurpose bottle, but the patent did not cover any of the features as mentioned in the present invention. The inventor of the present multipurpose bottle system is not aware of another multipurpose bottle system that has all the features of the invention disclosed herein which provides advantages for people who need it most, such as those who travel, work, or go to the gym.

In today's technologically-based world, there is a need for a system that can provide features such as a smartphone charger, smartphone holder, Bluetooth speaker, and storage space to keep important personal items so that they are not misplaced in transit. The present invention provides all such features in a single system.

All of the inventions listed above and many others enlisted in the prior art with a specific set of features but none of the inventions provide an assembly that provides not only conventional features but also provides advanced features to improve users' experience in handling the bottle assembly. None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary object of the invention is related to advancement in offering a system that is useful in the course of daily work and activities.

It is also the primary object of the invention to provide a multipurpose system that has multiple functions and uses. The multipurpose system will be very useful for working people, people who travel often, and for people who go to the gym.

It is further the objective of the invention to provide an aesthetically pleasing assembly that provides easy access to water for hydration for biking and jogging with safety LED and rechargeable better so one doesn't have to carry water bottles and worry about dying battery and have a pouch for all other items.

It is the further objective of the present invention to provide a simplicity of its design which is easy to hold and economical to manufacture.

It is also the objective of the invention to provide portability. Being wide open, sturdy holding place and light-in-weight enable a user to take it on business trips, vacations, or any on the go activity easily.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 shows the front view of the assembly as per preferred embodiments of the invention.

FIG. 2 shows the back view of the proposed assembly as per preferred embodiments of the invention.

FIG. 3 shows the working view as per preferred embodiments of the invention.

FIG. 4 shows another wiring view as per preferred embodiments of the invention.

FIG. 5 shows the perspective view as per preferred embodiments of the invention.

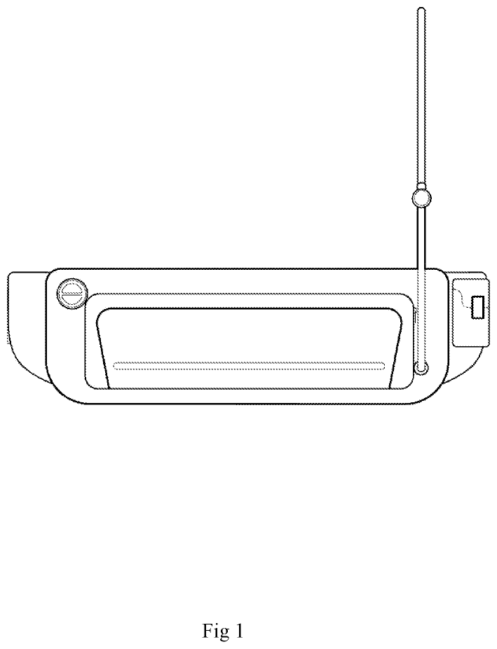

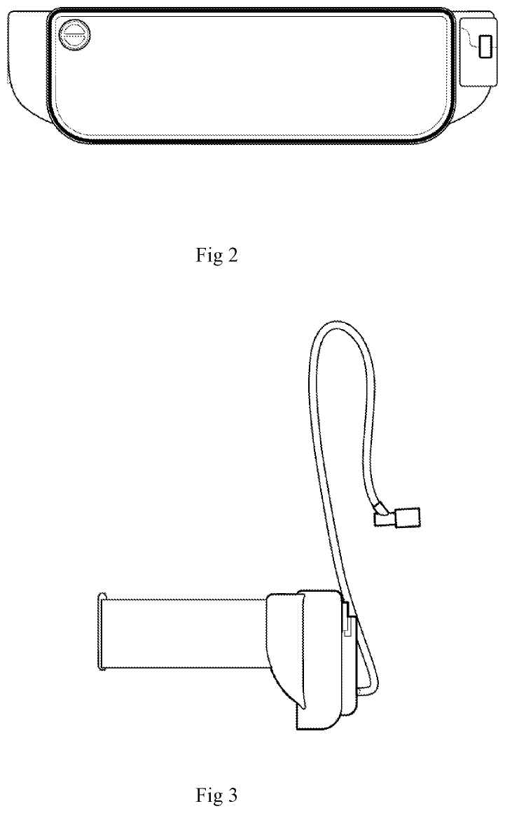

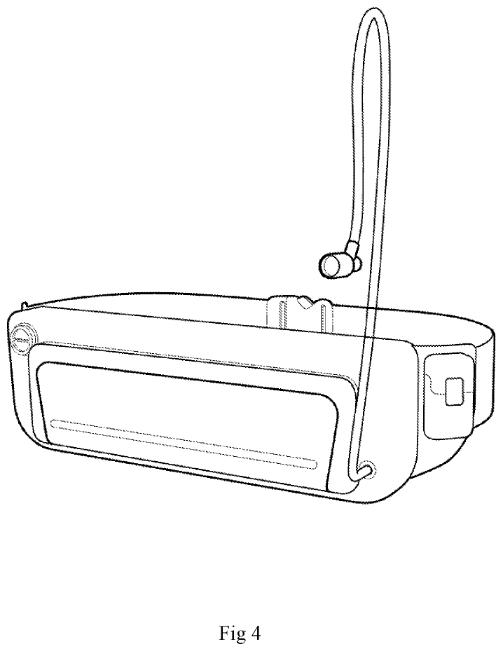

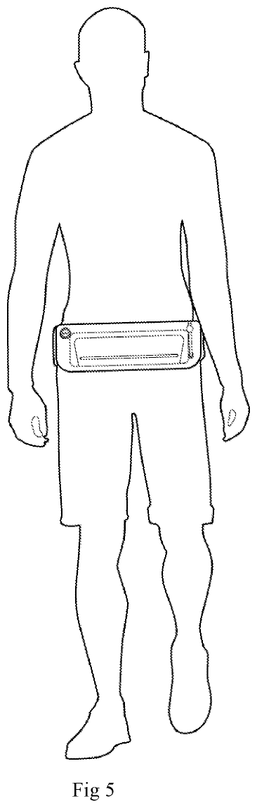

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The current invention proposes a multi-purpose system with insulation to keep the water in the bottle cool for a longer period of time, a smartphone holder/charger, a safety LED and storage space for personal items such as keys, credit cards, money etc.

In one aspect, the system may comprise the insulated water bottle, the smartphone holder/charger, the safety LED and the storage space for personal items such as keys, credit cards, money, etc.

The multipurpose system may have single or dual layers for insulation: The first layer contains air to insulate the contents of the bottle (e.g., water) from outside temperatures, and the optional second layer is coated with a gel to keep the water freezing cold.

The multipurpose system may also have a battery integrated with a USB outlet so that people can charge their phone anytime and anywhere. Of course, the battery may be an optional feature and therefore present in some implementations and not present in other implementations. The smartphone holder may have magnets affixed inside, adjacent to or in contact with the to hold the phone straight and firmly attached to the holder. The multipurpose system also may have a safety LED to provide the lighting option to user anywhere anytime. The system also may have a storage compartment in the base, or elsewhere, to keep personal belongings safe, such as credit cards, ID cards, keys, money, etc.

The main body of the proposed assembly includes a fanny-pack with a water belly for up to 2 milter of water. The main body also includes an electronic box subassembly made up of a pair of mating halves parts, which holds a pair of rechargeable batteries within a compartment formed by the two mating halves. The batteries are used to recharge the phone and act as a backup battery bank for the phone. The batteries provide this function by transmitting electricity via a USB outlet. An outlet adapter is connected to it, which is specialized to specific phone models according to the phone power input.

A storage chamber is positioned within the device to act as a storage place for holding credit cards, IDs, or money such as shown by a personal item pocket, or any other important personal belongings. The rechargeable batteries are used to recharge the phone and power the speaker. The bottom cover holds all the electronics and the personal item pocket provides a means of holding ID cards, etc. An LED is positioned adjacent to the water pack and is used to reflect light during the night, and is useful for a person walking on the road or traveling at night.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A multipurpose water storage, water bladder system integrated with fanny pack that contains a main body and a water bottle removably mounted to the main body, wherein the main body includes a smartphone charger, a smartphone holder, and a LED light.

2. The multipurpose system of claim 1, wherein the main body further comprises a storage chamber.

3. The multipurpose system of claim 1, wherein the main body further comprises a fanny-pack with water belly for up to 2 milters of water.

4. The multipurpose system of claim 1, wherein the main body further includes a battery pack for recharging mobile and other electronics.

5. The multipurpose system of claim 1, wherein the main body further includes a retractable water pipe that goes back into the fanny-pack attached to the water belly integrated with the fanny-pack.
